(19) United States
(12) Patent Application Publication
(10) Pub. No.: US 2022/0042952 A1
(43) Pub. Date: Feb. 10, 2022

(54) STATE ESTIMATION DEVICE AND STATE ESTIMATION METHOD

(71) Applicant: Mitsubishi Electric Corporation, Tokyo (JP)

(72) Inventor: Toshiyuki KURIYAMA, Tokyo (JP)

(73) Assignee: Mitsubishi Electric Corporation, Tokyo (JP)

(21) Appl. No.: 17/508,257

(22) Filed: Oct. 22, 2021

Related U.S. Application Data
(63) Continuation of application No. PCT/JP2019/019903, filed on May 20, 2019.

(51) Int. Cl. G01N 29/44; G06K 9/00; G06K 9/62; G05B 15/02; G01N 29/14

(52) U.S. Cl. CPC G01N 29/4454; G06K 9/0053; G01N 29/14; G06K 9/6218; G05B 15/02; G06K 9/00503

(57) ABSTRACT

A state estimation device calculates a state transition table indicating a state transition assumed in an object every time a connection pattern between partial waveforms is changed, selects a connection pattern from the state transition table on the basis of entropy that is a statistical index of the state transition of the object, and estimates a state of the object at each time and a state transition of the object on the basis of the selected connection pattern.

### CROSS REFERENCE TO RELATED APPLICATIONS

This application is a Continuation of PCT International Application No. PCT/JP2019/019903, filed on May 20, 2019, which is hereby expressly incorporated by reference into the present application.

### TECHNICAL FIELD

The present invention relates to a state estimation device and a state estimation method for estimating a state of an object on the basis of time-series data of detection information detected from the object by a sensor.

### BACKGROUND ART

Conventionally, there has been known a technique of estimating a state of an object on the basis of time-series data of detection information detected from the object by a sensor. For example, Patent Literature 1 discloses a device that acquires movement locus data that is time-series data of a position of a mobile object detected at constant time intervals, divides the movement locus data at equal intervals to generate a plurality of pieces of partial locus data, and estimates an action (state) of the mobile object using the plurality of pieces of partial locus data.

### CITATION LIST

### Patent Literature

Patent Literature 1; JP 2009-157770A

### SUMMARY OF INVENTION

### Technical Problem

In the device described in Patent Literature 1, a waveform of time-series data is divided at equal intervals to generate a plurality of partial waveforms, and a state of an object is estimated using a clustering result of these partial waveforms directly. Thus, when the waveform of the time-series data varies, it is not possible to distinguish between the variation caused by the abnormality of the object and the variation within the error range not caused by the abnormality of the object, so that there is a problem that the accuracy of the state estimation of the object decreases.

In addition, in a case where the length (time length) of a specific process among a series of processes for manufacturing a product is different depending on the product to be manufactured, the waveform of the time-series data obtained in the series of processes is different for each product. Thus, in a case where the waveform of the time-series data is divided at equal intervals, partial data corresponding to the state of the object cannot be obtained, and the accuracy of the state estimation of the object may be deteriorated.

The present invention solves the above problems, and an object of the present invention is to obtain a state estimation device and a state estimation method capable of preventing deterioration in state estimation accuracy of an object.

### Solution To Problem

A state estimation device according to the present invention includes processing circuitry to perform division of a waveform of time-series data detected from an object into a plurality of partial waveforms by a first division number and a second division number larger than the first division number, to extract a feature of each of the plurality of partial waveforms to cluster the plurality of partial waveforms on a basis of the feature of each of the plurality of partial waveforms, to calculate a state transition table indicating a state transition assumed for the object every time a connection pattern between the plurality of partial waveforms divided by the second division number is changed, and to select the connection pattern from the state transition table on a basis of a statistical index of the state transition of the object, and to estimate a state of the object at each time and the state transition of the object on a basis of the connection pattern selected.

### ADVANTAGEOUS EFFECTS OF INVENTION

According to the present invention, a state transition table indicating a state transition assumed in an object is calculated every time a connection pattern between partial waveforms is changed, a connection pattern is selected from the state transition table on the basis of a statistical index of the state transition of the object, and a state of the object at each time and a state transition of the object are estimated on the basis of the selected connection pattern. As a result, it is possible to prevent a decrease in the state estimation accuracy of the object.

### BRIEF DESCRIPTION OF DRAWINGS

FIG. 1 is a block diagram showing a configuration of a state estimation device according to a first embodiment.

FIG. 2A is a diagram illustrating an example of time-series data (no variation) handled in the first embodiment. FIG. 2B is a diagram illustrating an example of time-series data (with variation) handled in the first embodiment.

FIG. 3 is a flowchart showing a state estimation method according to the first embodiment.

FIG. 4 is a diagram illustrating an outline of time-series data division processing in the first embodiment.

FIG. 5 is a diagram illustrating an outline of feature extraction processing of a partial waveform in the first embodiment.

FIG. 6 is a diagram illustrating an outline of clustering processing of partial waveforms in the first embodiment.

FIG. 7 is a diagram illustrating connection point candidates of partial waveforms in the first embodiment.

FIG. 8 is a diagram illustrating an example of a state transition table before update.

FIG. 9 is a diagram illustrating an example of a state transition table when partial waveforms are connected at a connection point candidate (1a).

FIG. 10 is a diagram illustrating an example of a state transition table when partial waveforms are connected at a connection point candidate (2a).

FIG. 11 is a diagram illustrating an example of a state transition table when partial waveforms are connected at a connection point candidate (3a),

FIG. 12 is a diagram illustrating an outline of connection pattern selection processing in the first embodiment.

FIG. 13A is a block diagram showing a hardware configuration for implementing functions of the state estimation device according to the first embodiment. FIG. 13B is a block diagram showing a hardware configuration for executing software that implements functions of the state estimation device according to the first embodiment.

### DESCRIPTION OF EMBODIMENTS

### First Embodiment

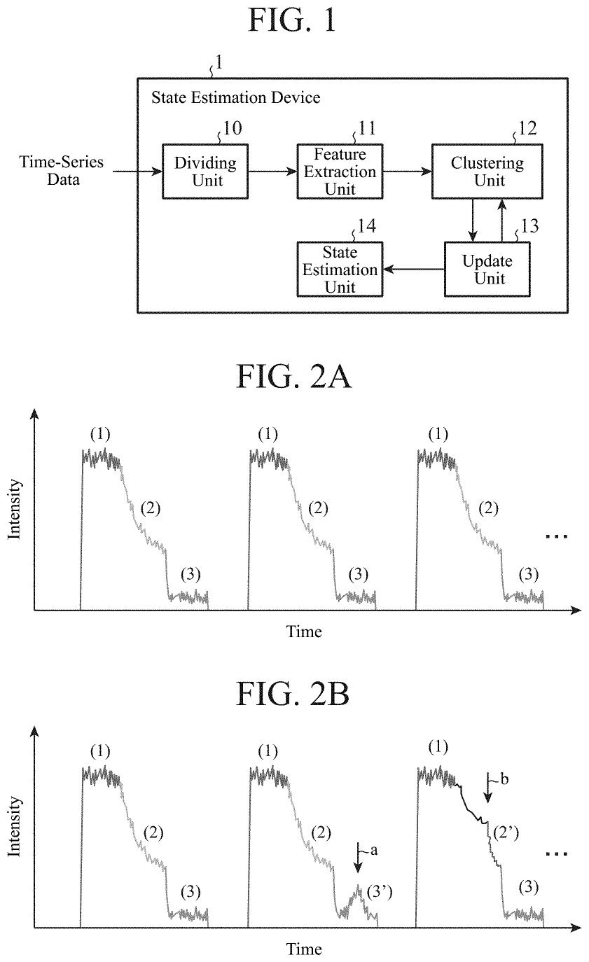

FIG. 1 is a block diagram showing a configuration of a state estimation device 1 according to the first embodiment. The state estimation device 1 is a device that estimates a state of an object indicated by time-series data of detection information detected from the object. Examples of the object include a power plant such as thermal power, hydraulic power, or nuclear power, a control system that controls a process of a chemical plant, a steel plant, or a water and sewage plant, a control system such as air conditioning, electricity, lighting, and supply and discharge of water in a facility, equipment provided in a manufacturing line of a factory, equipment mounted on an automobile or a railway vehicle, an information system regarding economy or management, or a person.

The detection information relates to a state of an object detected from the object by a sensor or the like. For example, in a case where the object is a machine tool, the detection information includes vibration generated in the machine tool when a product is manufactured. In addition, the waveform of time-series data of the detection information indicates a state transition of the object. For example, in a case where the object is a machine tool, the detection information is vibration generated in the machine tool when a product is manufactured, and the machine tool manufactures one product in a plurality of processes, the waveform of time-series data obtained in the course of manufacturing one product by the machine tool is a waveform in which waveforms corresponding to the states of the machine tool for the respective processes are connected.

In addition, when the time during which one product is manufactured by the machine tool is defined as a data detection time, similar waveforms are continuously detected every time the same product is manufactured by the machine tool, that is, every data detection time. The time-series data handled by the state estimation device 1 is data in which similar waveforms are continuously shown in time series and a change in the waveform corresponding to the state transition of the object is obtained in each waveform.

As illustrated in FIG. 1, the state estimation device 1 includes a dividing unit 10, a feature extraction unit 11, a clustering unit 12, an update unit 13, and a state estimation unit 14. The dividing unit 10 divides the waveform of the time-series data by a first division number and divides the waveform by a second division number larger than the first division number. The first division number corresponds to the number of states that the object can take, and is, for example, a division number designated in advance by the user. The second division number is a division number obtained by adding a predetermined number α to the first division number, and for example, α=1.

The feature extraction unit 11 extracts features from each of a plurality of partial waveforms obtained by dividing the time-series data by the dividing unit 10. The features of a partial waveform includes a length, a slope, or a curvature of the partial waveform. In addition, the features of a partial waveform may be a statistic such as a minimum value, a maximum value, an average value, or a standard deviation of data constituting the waveform.

The clustering unit 12 clusters the partial waveforms on the basis of features of the respective partial waveforms extracted by the feature extraction unit 11. The k-mean method or the K-NN method can be used for clustering. For example, in a case where the machine tool manufactures one product in three processes from the first process to the third process, the clustering unit 12 clusters the partial waveforms corresponding to the first process into the state (1), clusters the partial waveforms corresponding to the second process into the state (2), and clusters the partial waveforms corresponding to the third process into the state (3).

The update unit 13 calculates a state transition table every time the connection pattern between the partial waveforms divided by the second division number by the dividing unit 10 is changed, and selects the connection pattern from the stale transition table on the basis of the statistical index of the state transition of the object. The state transition table is table data indicating a state transition assumed for the object, and for example, the frequency of the state transition determined from the clustering result of the partial waveform is set in the table data. In addition, examples of the statistical index of the state transition of the object include entropy. The entropy is calculated using the frequency of the state transition set in the state transition table. Note that the index used to select the state transition table may be any value that can be a statistical index of the state transition of the object, and is not limited to the entropy.

The state estimation unit 14 estimates the state of the object at each time and the state transition of the object on the basis of the state transition table selected by the update unit 13. For example, the state estimation unit 14 labels the partial waveform corresponding to the state of the object at each time by referring to the state transition table, and calculates a transition probability of the state at each time. For the calculation of the transition probability of the state, a known method for obtaining a parameter of the state transition such as the hidden Markov model can be used.

Next, the time-series data will be described. FIG. 2A is a diagram illustrating an example of time-series data (no variation) handled in the first embodiment. FIG. 2B is a diagram illustrating an example of time-series data. (with variation) handled in the first embodiment. The time-series data illustrated in FIGS. 2A and 2B is time-series data of vibration generated in a machine tool when a product is manufactured. For example, a worker gives a command to the machine tool to operate in the order of step (a), step (b), and step (c), The machine tool manufactures a product by sequentially executing step (a), step (b), and step (c) in accordance with this command.

Vibration generated in a machine tool when a product is manufactured is detected by a sensor provided in the machine tool, and waveform data of vibration corresponding to each process is obtained. When the machine tool manufactures the same product in the same process, ideally, as illustrated in FIG. 2A, the same waveform is repeatedly detected every data detection time. For example, the state of vibration of the machine tool corresponding to step (a) is state (1), the state of vibration of the machine tool corresponding to step (b) is state (2), and the state of vibration of the machine tool corresponding to step (c) is state (3).

However, in practice, the same waveform may not be obtained due to a change in vibration generated in the machine tool due to individual differences of products or the like. For example, as indicated by an arrow a in FIG. 2B, the state (3) of vibration of the machine tool corresponding to the process (c) may change to a state (3′) different from the state (3), and as indicated by an arrow b, the state (2) of vibration of the machine tool corresponding to the process (b) may change to a state (2′) different from the state (2).

When the individual difference of the product is within the allowable range, the state (2′) of the machine tool is the normal state in the process (b), and the state (3′) is the normal state in the process (c). That is, the state (2′) is a variation within a normal range of a vibration intensity in the step (b), and the state (3′) is a variation within a normal range of a vibration intensity in the step (c). In the conventional state estimation device, in a case where the time-series data is normal but the state of the object varies as described above, the state of the object cannot be accurately estimated.

On the other hand, the state estimation device 1 calculates the state transition table every time the connection pattern between the partial waveforms is changed, selects the connection pattern from the state transition table on the basis of the statistical index of the state transition of the object, and estimates the state of the object at each time and the state transition of the object on the basis of the selected connection pattern. As a result, it is possible to prevent a decrease in the state estimation accuracy of the object.

Next, a state estimation method according to the first embodiment will be described.

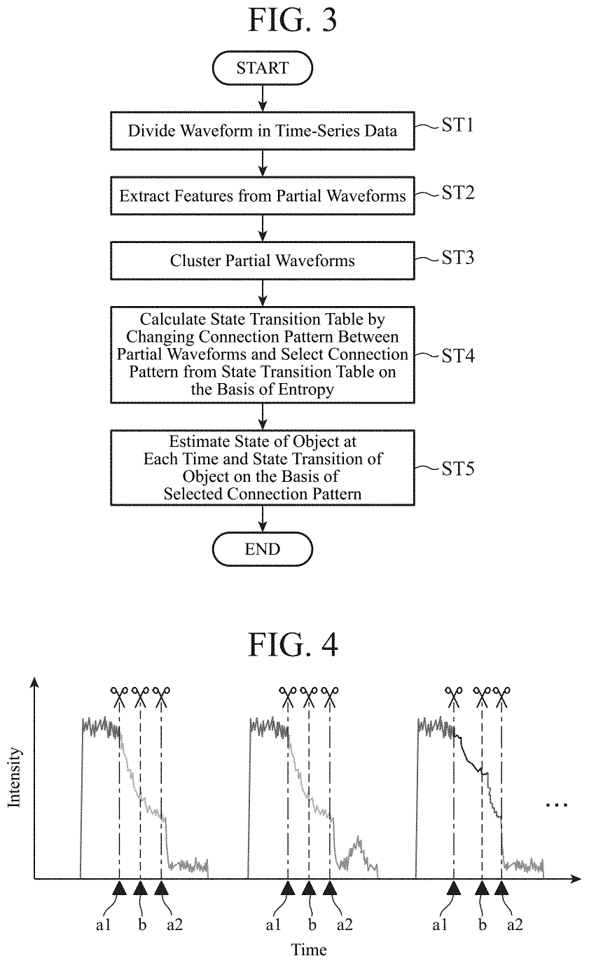

FIG. 3 is a flowchart showing the state estimation method according to the first embodiment, and shows the operation of the state estimation device 1. The dividing unit 10 sequentially acquires time-series data for each data detection time, and divides the time-series data to generate a plurality of partial waveforms (step ST1). The dividing unit 10 divides the time-series data by the first division number and the second division number. As a time-series data division method, there is the Ramer Douglas Peucker algorithm (hereinafter, described as the RDP algorithm).

In the RDP algorithm, among points (detection information) constituting the waveform of the time-series data, points having large convexity in the shape of the waveform are set as division points. The RDP algorithm includes, for example, a procedure (1) to a procedure (4). In the procedure (1), the head point and the last point of the time-series data are connected by a line segment. In the procedure (2), points separated by a threshold or more distance from the line segment obtained in the procedure (1) in the waveform of the time-series data are searched, and the point farthest from the line segment among the searched points is plotted. In the procedure (3), plotted points are connected by line segments. The procedure (2) and the procedure (3) are recursively repeated. By changing the threshold, the dividing unit 10 can divide the waveform of the time-series data by the first division number and divide the waveform by the second division number.

FIG. 4 is a diagram illustrating an outline of division processing of time-series data in the first embodiment, and illustrates a case where division processing is performed on the time-series data illustrated in FIG. 2B. In FIG. 4, the first division number is 3″, and the second division number is “4”. In a case where the waveform of the time-series data is divided by the first division number, the dividing unit 10 performs division processing on the time-series data in accordance with the RDP algorithm using the threshold corresponding to the division number “3”, so that the division points are determined as a1 and a2, and the waveform of the time-series data is divided at the division points a1 and a2. As a result, three partial waveforms are generated from one piece of time-series data. On the other hand, in a case where the waveform of the time-series data is divided by the second division number, the dividing unit 10 performs the division processing on the time-series data in accordance with the RDP algorithm using the threshold corresponding to the division number “4”, so that the division points are determined as a1, b, and a2, and the waveform of the time-series data is divided at the division points a1, b, and a2. As a result, four partial waveforms are generated from one piece of time-series data.

Next, the feature extraction unit 11 extracts features from partial waveforms obtained by dividing the time-series data by the dividing unit 10 (step ST2). For example, the feature extraction unit 11 extracts a slope or a curvature of a partial waveform. The feature extraction unit 11 outputs data in which the partial waveforms and the features thereof are associated with each other to the clustering unit 12.

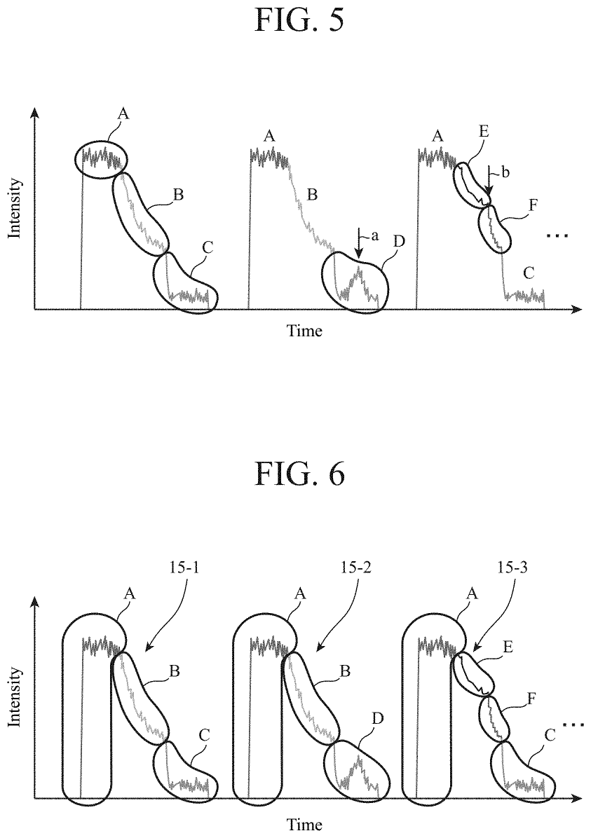

FIG. 5 is a diagram illustrating an outline of the feature extraction processing of the partial waveform in the first embodiment, and illustrates a case where the feature extraction processing is performed on the partial waveform obtained from the time-series data illustrated in FIG. 2B. For example, when the waveform of the time-series data is divided at the division points a1 and a2 illustrated in FIG. 4, a partial waveform A, a partial waveform B, a partial waveform C, and a partial waveform D are obtained, and thus, the feature extraction unit 11 extracts features of each of these partial waveforms. In addition, when the waveform of the time-series data is divided at the division points a1, b, and a2, a partial waveform A, a partial waveform E, a partial waveform F, and the partial waveform C are obtained, and thus, the feature extraction unit 11 extracts features of each of these partial waveforms.

Subsequently, the clustering unit 12 clusters the partial waveforms (step ST3). For example, the clustering unit 12 clusters partial waveforms having similar shapes among partial waveforms of a plurality of pieces of continuous time-series data as the same state on the basis of the features of the partial waveforms extracted by the feature extraction unit 11. The processing in steps ST2 and ST3 is performed on the partial waveform obtained by dividing the time-series data by the first division number and the partial waveform obtained by dividing the time-series data by the second division number.

FIG. 6 is a diagram illustrating an outline of clustering processing of partial waveforms in the first embodiment, and illustrates a case where the partial waveforms obtained from the time-series data illustrated in FIG. 2B are clustered. For example, the clustering unit 12 clusters partial waveforms similar to the partial waveform A from a plurality of pieces of time-series data continuously detected for each data detection time and divided by the first division number on the basis of the feature of the partial waveform A extracted by the feature extraction unit 11. In addition, the clustering unit 12 clusters partial waveforms similar to the partial waveform B from a plurality of pieces of time-series data continuously detected for each data detection time and divided by the first division number on the basis of the feature of the partial waveform B extracted by the feature extraction unit 11. The clustering unit 12 clusters partial waveforms similar to the partial waveform C from a plurality of pieces of time-series data continuously detected for each data detection time and divided by the first division number on the basis of the feature of the partial waveform C extracted by the feature extraction unit 11. Further, the clustering unit 12 clusters partial waveforms similar to the partial waveform D from a plurality of pieces of time-series data continuously detected for each data detection time and divided by the first division number on the basis of the feature of the partial waveform D extracted by the feature extraction unit 11.

Similarly, clustering is also performed on partial waveforms obtained by dividing the time-series data by the second division number. For example, the clustering unit 12 clusters partial waveforms similar to the partial waveform E from a plurality of pieces of time-series data continuously detected for each data detection time and divided by the second division number on the basis of the feature of the partial waveform E extracted by the feature extraction unit 11. Further, the clustering unit 12 clusters partial waveforms similar to the partial waveform F from a plurality of pieces of time-series data continuously detected for each data detection time and divided by the second division number on the basis of the feature of the partial waveform F extracted by the feature extraction unit 11.

Here, the partial waveform A is data indicating the state (1) of the object, the partial waveform B is data indicating the state (2) of the object, and the partial waveform C is data indicating the state (3) of the object. On the other hand, the partial waveform D is data indicating a state (4) in which variation occurs in the state (3) as indicated by an arrow a in FIG. 5. Further, the partial waveform F is data indicating the state (5) of the object, and the partial waveform G is data indicating the state (6) of the object.

Time-series data 15-3 from which the partial waveform E and the partial waveform F have been obtained has a point having large convexity as indicated by an arrow b in FIG. 5, and this point is set as a division point by the RDP algorithm. This point is set as a division point by the RDP algorithm also when division is performed by the first division number. Thus, the three partial waveforms obtained when the time-series data 15-3 is divided by the first division number have different features from the partial waveforms A to C obtained when the time-series data 15-1 is divided by the first division number.

As a determination condition, when the number of states of the object indicated by each of the plurality of pieces of time-series data continuously detected for each data detection time is the same and the order (state transition) in which the states occur in each piece of time-series data is the same, it can be determined that the object is normal even if the waveform of the time-series data is disturbed. For example, when the waveform of the time-series data 15-1 is divided by the first division number, the partial waveform A, the partial waveform B, and the partial waveform C are obtained, and these waveforms are connected in this order. Therefore, the time-series data 15-1 is determined to be time-series data obtained from a normal object.

In addition, when the waveform of the time-series data. 15-2 is divided by the first division number, the partial waveform A, the partial waveform B, and the partial waveform D are obtained, and these waveforms are sequentially connected. When the difference between the state (4) corresponding to the partial waveform D and the state (3) corresponding to the partial waveform C is within the allowable range, the time-series data 15-2 is determined to be time-series data obtained from a normal object.

On the other hand, in the waveform of the time-series data 15-3, when divided by the first division number, three partial waveforms having features different from the partial waveforms A to C are obtained, and when divided by the second division number, the partial waveform E corresponding to the state (5) that the object cannot take and the partial waveform F corresponding to the state (6) that the object cannot take are obtained.

In a conventional state estimation method, the waveform of the time-series data is divided at equal intervals to generate partial waveforms, and the state of the object is estimated using the clustering result of these partial waveforms directly. Therefore, the state (5) and the state (6) that cannot be taken by the object are estimated from the time-series data 15-3. As a result, even if the time-series data 15-3 is obtained from a normal object, it is erroneously determined that the time-series data is obtained from an object in which an abnormality has occurred.

On the other hand, in the state estimation device 1, since the connection pattern between the partial waveforms is changed and the most probable state transition is selected, it is determined that the partial waveform E and the partial waveform F are waveforms corresponding to the partial waveform B, and erroneous determination can be prevented.

In order to select the most probable state transition, the update unit 13 calculates the state transition table by changing the connection pattern between the partial waveforms, and selects the connection pattern from the state transition table on the basis of the entropy (step ST4). For example, in the time-series data 15-3, as described above, the three partial waveforms obtained when the waveform is divided by the first division number have features different from the partial waveforms A to C, and when the waveform is divided by the second division number, the partial waveform E corresponding to the state (5) that the object cannot take and the partial waveform F corresponding to the state (6) that the object cannot take are obtained. Therefore, the update unit 13 performs the processing of step ST4 on the partial waveform E and the partial waveform F obtained from the waveform of the time-series data 15-3.

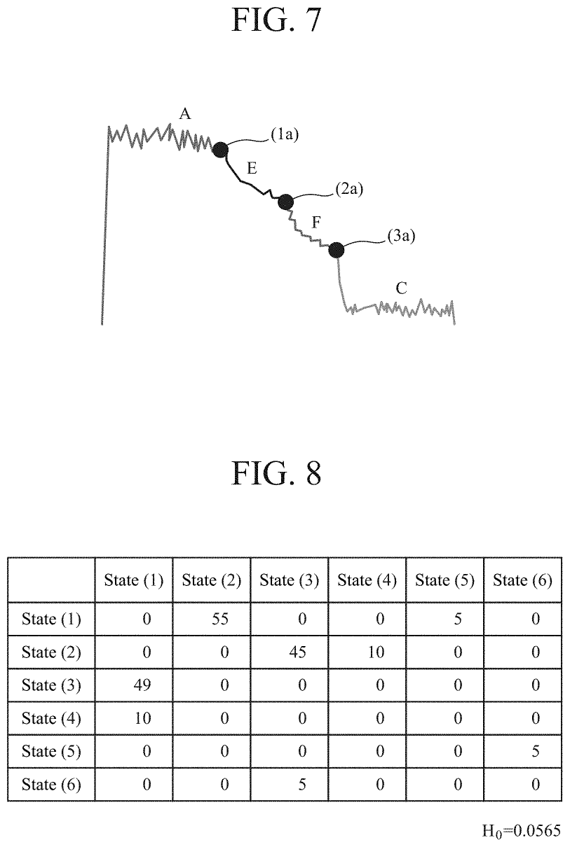

FIG. 7 is a diagram illustrating connection point candidates of partial waveforms in the first embodiment. The connection point candidate is a candidate of a point connecting the partial waveforms, and is a division point when the time-series data is divided by the second division number. The time-series data illustrated in FIG. 7 includes a connection point candidate (1a) that connects the partial waveform A and the partial waveform E, a connection point candidate (2a) that connects the partial waveform E and the partial waveform F, and a connection point candidate (3a) that connects the partial waveform F and the partial waveform C. A connection pattern in which partial waveforms are connected to each other is handled as one partial waveform.

First, the update unit 13 calculates a state transition table before the partial waveforms are connected to each other, and calculates entropy Ho from the state transition table. FIG. 8 is a diagram illustrating an example of the state transition table before the update, and illustrates the state transition table before the partial waveforms are connected to each other. In the state transition table illustrated in FIG. 8, the frequency of the transition from the state (1) to the state (2) corresponding to the change from the partial waveform A to the partial waveform B is 55 times, and the frequency of the transition from the state (2) to the state (3) corresponding to the change from the partial waveform B to the partial waveform C is 45 times. In addition, the frequency of the transition from the state (3) to the state (1) corresponding to the change from the partial waveform C to the partial waveform A of the next time-series data is 49 times.

In addition, the frequency of the transition from the state (2) to the state (4) due to the partial waveform D is 10 times. The frequency of the transition from the state (4) to the state (1) corresponding to the change from the partial waveform D to the partial waveform A of the next time-series data is 10 times, Furthermore, the frequency of the transition from the state (1) to the state (5) due to the partial waveform E is five times, and the frequency of the transition from the state (6) to the state (3) due to the partial waveform F is five times. The frequency of the transition from the state (5) to the state (6) due to the partial waveform E and the partial waveform F is five times.

The update unit 13 calculates entropy H from the following formula (1) using the frequency of the state transition set in the state transition table illustrated in FIG. 8, In the following formula (1), X is the state of the object, and t is the type of the state X (states (1) to (5)). P(X) is an occurrence probability that the state X occurs. Entropy H₀32 0.0565 is calculated from the frequency of the state transition set in the state transition table illustrated in FIG. 8.

H=−Σ[X ∈Ω]P9X)log P(X) (1)

Next, the update unit 13 calculates a state transition table with a connection pattern in which the partial waveform A and the partial waveform E are connected at the connection point candidate (1a), and calculates entropy H₁ from the state transition table.

For example, the update unit 13 causes the clustering unit 12 to perform clustering again on the waveform in which the partial waveform A and the partial waveform E are connected at the connection point candidate (1a). As a result, the waveform in which the partial waveform A and the partial waveform E are connected at the connection point candidate (1a) is clustered with the partial waveform A.

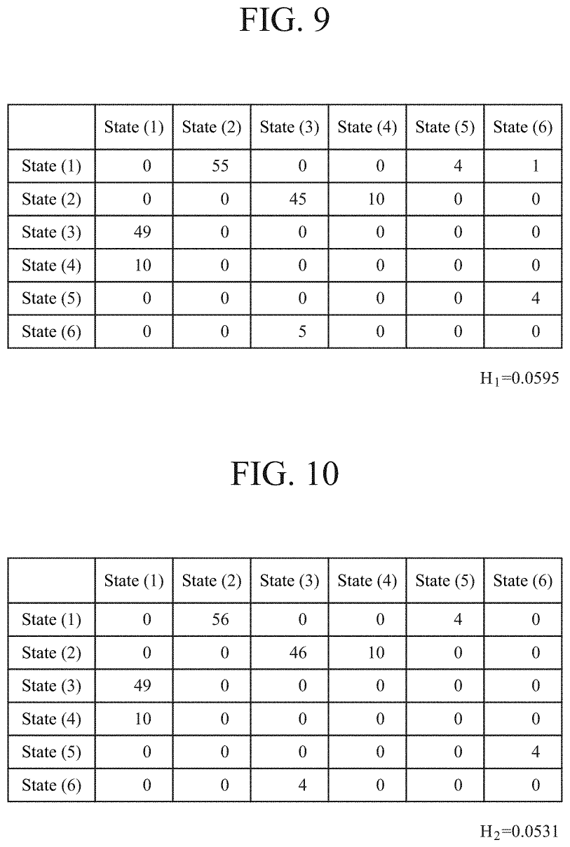

FIG. 9 is a diagram illustrating an example of a state transition table when partial waveforms are connected at the connection point candidate (1a). In the state transition table illustrated in FIG. 9, the frequency of the transition from the state (1) to the state (2) corresponding to the change from the partial waveform A to the partial waveform B is 55 times, and the frequency of the transition from the state (2) to the state (3) corresponding to the change from the partial waveform B to the partial waveform C is 45 times. In addition, the frequency of the transition from the state (3) to the state (1) corresponding to the change from the partial waveform C to the partial waveform A of the next time-series data is 49 times.

The frequency of the transition from the state (2) to the state (4) due to the partial waveform D is 10 times. The frequency of the transition from the state (4) to the state (1) indicated by the change from the partial waveform D to the partial waveform A of the next time-series data is 10 times. The frequency of the transition from the state (1) to the state (5) due to the partial waveform E is four times, and the frequency of the transition from the state (6) to the state (3) due to the partial waveform F is five times. The frequency of the transition from the state (5) to the state (6) due to the partial waveform E and the partial waveform F is four times. In addition, since the partial waveform A and the partial waveform E are connected and clustered with the partial waveform A, the transition from the state (1) to the state (6) is added once.

The update unit 13 calculates entropy H₁=0.0595 from the above formula (1) using the frequency of the state transition set in the state transition table illustrated in FIG. 9.

Next, the update unit 13 calculates a state transition table with a connection pattern in which the partial waveform E and the partial waveform F are connected at the connection point candidate (2a), and calculates entropy H₂ from the state transition table.

For example, the update unit 13 causes the clustering unit 12 to perform clustering again on the waveform in which the partial waveform E and the partial waveform F are connected at the connection point candidate (2a). As a result, the waveform in which the partial waveform E and the partial waveform F are connected at the connection point candidate (2a) is clustered with the partial waveform B.

FIG. 10 is a diagram illustrating an example of a state transition table when partial waveforms are connected at a connection point candidate (2a). Since the partial waveform E and the partial waveform F are connected and clustered with the partial waveform B, the frequency of the transition from the state (1) to the state (2) corresponding to the change from the partial waveform A to the partial waveform B increases to 56 times, and the frequency of the transition from the state (2) to the state (3) corresponding to the change from the partial waveform B to the partial waveform C increases to 46 times. In addition, the frequency of the transition from the state (3) to the state (1) corresponding to the change from the partial waveform C to the partial waveform A of the next time-series data is 49 times.

In addition, the frequency of the transition from the state (2) to the state (4) due to the partial waveform D is 10 times. The frequency of the transition from the state (4) to the state (1) indicated by the change from the partial waveform D to the partial waveform A of the next time-series data is 10 times. The frequency of the transition from the state (1) to the state (5) due to the partial waveform E is four times, and the frequency of the transition from the state (6) to the state (3) due to the partial waveform F is five times. The frequency of the transition from the state (5) to the state (6) due to the partial waveform E and the partial waveform F is four times. The update unit 13 calculates entropy H₂=0.0531 from the above formula (1) using the frequency of the state transition set in the state transition table illustrated in FIG. 10.

Next, the update unit 13 calculates a state transition table with a connection pattern in which the partial waveform F and the partial waveform C are connected at the connection point candidate (3a), and calculates entropy H₃ from the state transition table.

For example, the update unit 13 causes the clustering unit 12 to perform clustering again on the waveform in which the partial waveform F and the partial waveform C are connected at the connection point candidate (3a). As a result, the waveform in which the partial waveform F and the partial waveform C are connected at the connection point candidate (3a) is clustered with the partial waveform F.

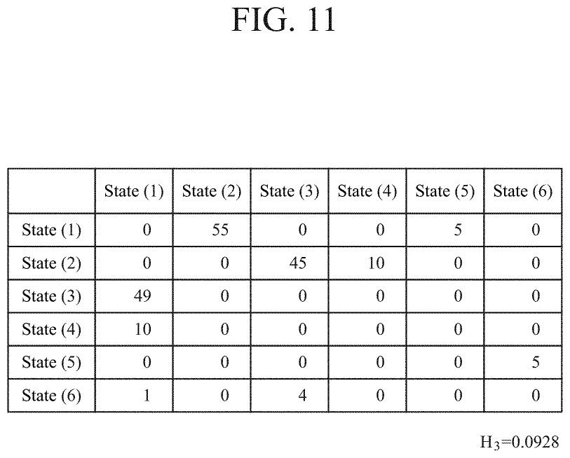

FIG. 11 is a diagram illustrating an example of a state transition table when partial waveforms are connected at the connection point candidate (3a). In the state transition table illustrated in FIG. 11, the frequency of the transition from the state (1) to the state (2) corresponding to the change from the partial waveform A to the partial waveform B is 55 times, and the frequency of the transition from the state (2) to the state (3) corresponding to the change from the partial waveform B to the partial waveform C is 45 times. In addition, the frequency of the transition from the state (3) to the state (1) corresponding to the change from the partial waveform C to the partial waveform A of the next time-series data is 49 times.

The frequency of the transition from the state (2) to the state (4) due to the partial waveform D is 10 times. The frequency of the transition from the state (4) to the state (1) corresponding to the change from the partial waveform D to the partial waveform A of the next time-series data is 10 times. The frequency of the transition from the state (1) to the state (5) due to the partial waveform E is five times. Since the waveform in which the partial waveform F and the partial waveform C are connected is clustered with the partial waveform F, the frequency of the transition from the state (6) to the state (3) due to the partial waveform F is four times, and the frequency of the transition from the state (5) to the state (6) due to the partial waveform E and the partial waveform F is five times. The transition from the state (6) to the state (1) corresponding to the change from the partial waveform F to the partial waveform A of the next time-series data is added once.

The update unit 13 calculates entropy H₃=0.0928 from the above formula (1) using the frequency of the state transition set in the state transition table illustrated in FIG. 11.

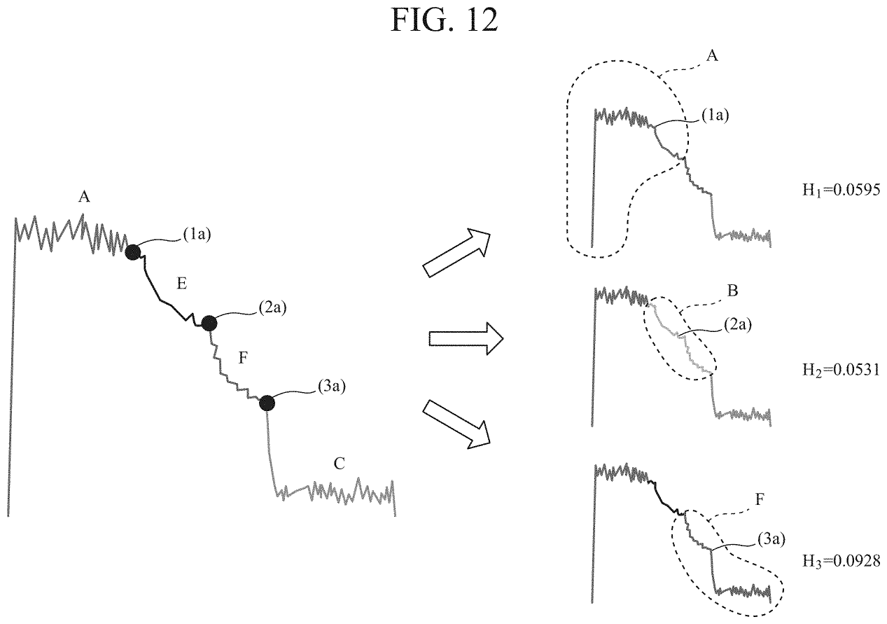

FIG. 12 is a diagram illustrating an outline of connection pattern selection processing according to the first embodiment. The entropy H calculated using the above formula (1) is a statistical index indicating the degree of variation in state transition. It can be said that the smaller the value of entropy H, the smaller the degree of variation and the more likely the state transition is. Thus, the update unit 13 specifies an entropy having the smallest value among the entropy H₁, H₂, and H₃. In the example illustrated in FIG. 12, since the value of the entropy H₂ is the minimum, the update unit 13 selects the state transition table illustrated in FIG. 10 corresponding to the entropy H₂ and selects a connection pattern from the state transition table. At this time, the state transition table illustrated in FIG. 8 calculated before connecting the partial waveforms is updated to the state transition table illustrated in FIG. 10.

Note that although the case where the processing of step ST4 is performed on the time-series data 15-3 has been described, the update unit 13 may perform the processing of step ST4 on all the time-series data in which the waveform is divided by the second division number to obtain four partial waveforms. As a result, the four partial waveforms including the partial waveform corresponding to the state that the object cannot take are corrected to three partial waveforms corresponding only to the states that the object can take.

The explanation returns to the description of FIG. 3.

The state estimation unit 14 estimates the state of the object at each time and the state transition of the object on the basis of the connection pattern selected by the update unit 13 (step ST5). For example, on the basis of the connection pattern selected from the state transition table, the state estimation unit 14 labels each partial waveform (partial waveform at each time) to indicate to which state the waveform corresponds. Furthermore, the state estimation unit 14 may calculate the state transition probability using the frequency of the state transition set in the state transition table. For the calculation of the state transition probability, a known technique for calculating a parameter of a state transition such as a hidden Markov model can be used.

Information indicating the state and the state transition of the object estimated by the state estimation unit 14 is used in an abnormality determination system that determines abnormality of the object, For example, the abnormality determination system can determine that an abnormality has occurred in the object when the state estimation unit 14 estimates a state that the object cannot take. Furthermore, for example, in a case where the partial waveform D appears more than the partial waveform C in the time-series data with the lapse of time, and the frequency at which the state (4) is estimated increases, the abnormality determination system can determine that the object has deteriorated.

Although the case where the state estimation device 1 handles time-series data in which similar waveforms are continuously detected has been described so far, it is also possible to handle time-series data in which dissimilar waveforms are detected.

For example, when a condition under which the time-series data have dissimilar waveforms is clear, the state estimation device 1 can process the time-series data in which dissimilar waveforms are detected similarly to the time-series data in which similar waveforms are continuously detected by correcting the change in the waveforms using this condition.

Next, the hardware configuration that implements the functions of the state estimation device 1 will be described.

The functions of the dividing unit 10, the feature extraction unit 11, the clustering unit 12, the update unit 13, and the state estimation unit 14 in the state estimation device 1 are implemented by a processing circuit. That is, the state estimation device 1 includes a processing circuit for executing the processing from step ST1 to step ST5 in FIG. 3. The processing circuit may be dedicated hardware or a central processing unit (CPU) that executes a program stored in a memory.

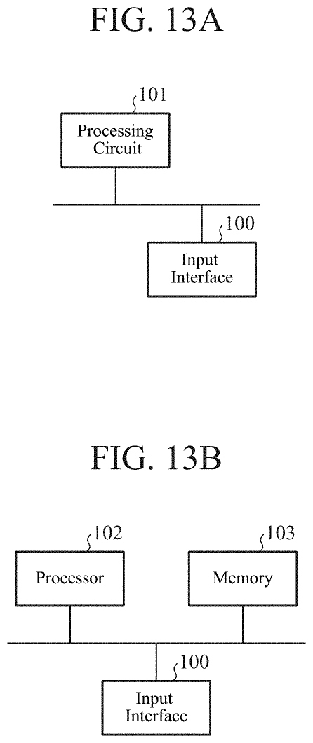

FIG. 13A is a block diagram showing a hardware configuration for implementing the functions of the state estimation device 1. Further, FIG. 13B is a block diagram showing a hardware configuration for executing software that implements the functions of the state estimation device 1. In FIGS. 13A and 13B, the input interface 100 is, for example, an interface that relays time-series data Output from a storage device in which time-series data is accumulated to the dividing unit 10 included in the state estimation device 1.

When the processing circuit is a processing circuit 101 of dedicated hardware shown in FIG. 13A, the processing circuit 101 corresponds, for example, to a single circuit, a composite circuit, a programmed processor, a parallel-programmed processor, an application specific integrated circuit (ASIC), a field-programmable gate array (FPGA), or a combination thereof. The functions of the dividing unit 10, the feature extraction unit 11, the clustering unit 12, the update unit 13, and the state estimation unit 14 in the state estimation device 1 may be implemented by separate processing circuits, or these functions may be collectively implemented by one processing circuit.

When the processing circuit is a processor 102 shown in FIG. 13B, the functions of the dividing unit 10, the feature extraction unit 11, the clustering unit 12, the update unit 13, and the state estimation unit 14 in the state estimation device 1 are implemented by software, firmware, or a combination of software and firmware. Note that, software or firmware is written as a program and stored in a memory 103.

The processor 102 reads and executes the program stored in the memory 103, thereby implementing the functions of the dividing unit 10, the feature extraction unit 11, the clustering unit 12, the update unit 13, and the state estimation unit 14 in the state estimation device 1. That is, the state estimation device 1 includes a memory 103 for storing programs in which the processing from step STI to step ST5 in the flowchart shown in FIG. 3 are executed as a result when executed by the processor 102. These programs cause a computer to execute procedures or methods performed by the dividing unit 10, the feature extraction unit 11, the clustering unit 12, the update unit 13, and the state estimation unit 14. The memory 103 may be a computer-readable storage medium storing a program for causing a computer to function as the dividing unit 10, the feature extraction unit 11, the clustering unit 12, the update unit 13, and the state estimation unit 14.

Examples of the memory 103 correspond to a nonvolatile or volatile semiconductor memory, such as a random access memory (RAM), a read only memory (ROM), a flash memory, an erasable programmable read only memory (EPROM), or an electrically-EPROM (EEPROM), a magnetic disk, a flexible disk, an optical disk, a compact disk, a mini disk, and a DVD.

The functions of the dividing unit 10, the feature extraction unit 11, the clustering unit 12, the update unit 13, and the state estimation unit 14 in the state estimation device 1 may be partially implemented by dedicated hardware and partially implemented by software or firmware. For example, the functions of the dividing unit 10, the feature extraction unit 11, and the clustering unit 12 are implemented by the processing circuit 101 which is the dedicated hardware, and the functions of the update unit 13 and the state estimation unit 14 are implemented by the processor 102 reading and executing the programs stored in the memory 103. Thus, the processing circuit can implement the above functions by hardware, software, firmware, or a combination thereof.

As described above, the state estimation device 1 according to the first embodiment calculates the state transition table indicating the state transition assumed for the object every time the connection pattern between the partial waveforms is changed, selects the connection pattern from the state transition table on the basis of entropy, and estimates the state of the object at each time and the state transition of the object on the basis of the selected connection pattern. As a result, it is possible to prevent a decrease in the state estimation accuracy of the object.

Note that, the present invention is not limited to the above-described embodiment, and within the scope of the present invention, it is possible to modify any component of the embodiment or omit any component of the embodiment.

### INDUSTRIAL APPLICABILITY

Since the state estimation device according to the present invention can prevent a decrease in the state estimation accuracy of the object, the state estimation device can be used for an abnormality determination system that determines an abnormality of the object from the estimated state.

### REFERENCE SIGNS LIST

1: state estimation device, 10: dividing unit, 11: feature extraction unit, 12: clustering unit, 13: update unit, 14: state estimation unit, 15-1 to 15-3: time-series data, 100: input interface. 101: processing circuit, 102: processor, 103: memory

1. A state estimation device comprising processing circuitry
to perform division of a waveform of time-series data detected from an object into a plurality of partial waveforms by a first division number and a second division number lamer than the first division number,
to extract a feature of each of the plurality of partial waveforms,
to cluster the plurality of partial waveforms on a basis of the feature of each of the plurality of partial waveforms,
to calculate a state transition table indicating a state transition assumed for the object every time a connection pattern between the plurality of partial waveforms divided by the second division number is changed, and to select the connection pattern from the state transition table on a basis of a statistical index of the state transition of the object, and
to estimate a state of the object at each time and the state transition of the object on a basis of the connection pattern selected.

2. The state estimation device according to claim 1, wherein the state transition table is selected on a basis of entropy indicating variation in frequency of a state transition of the object.

3. The state estimation device according to claim 1, wherein the division of the waveform of time-series data is performed in accordance with a Ramer Douglas Peucker algorithm.

4. A state estimation method performed by a state estimation device, the method comprising:
performing division of a waveform of time-series data detected from an object into a plurality of partial waveforms by a first division number and a second division number larger than the first division number;
extracting a feature of each of the plurality of partial waveforms;
clustering the plurality of the partial waveforms on a basis of the feature of each of the plurality of partial waveforms;
calculating a state transition table indicating a state transition assumed for the object every time a connection pattern between the plurality of partial waveforms divided by the second division number is changed, and to select the connection pattern from the state transition table on a basis of a statistical index of the state transition of the object; and
estimating a state of the object at each time and the state transition of the object on a basis of the connection pattern selected.
